(19) United States
(12) Patent Application Publication
(10) Pub. No.: US 2024/0177077 A1
(43) Pub. Date: May 30, 2024

(54) ATTRIBUTION ANALYSIS METHOD, ELECTRONIC DEVICE, AND STORAGE MEDIUM

(71) Applicant: Douyin Vision Co., Ltd., Beijing (CN)

(72) Inventor: Hao WANG, Beijing (CN)

(21) Appl. No.: 18/511,298

(22) Filed: Nov. 16, 2023

(30) Foreign Application Priority Data
Nov. 25, 2022 (CN) 202211488180.3

(51) Int. Cl. G06Q 10/063; G06Q 10/047

(52) U.S. Cl. CPC G06Q 10/063; G06Q 10/047

(57) ABSTRACT

The present disclosure provides an attribution analysis method, an electronic device, and a storage medium, wherein the method includes: acquiring target business data of an object to be analyzed, and acquiring a plurality of levels of data dimensions of the target business data; determining a target Trie tree based on the data dimensions and the target business data; determining a node contribution degree of each node in the target Trie tree based on the target business data; and performing an anomaly attribution analysis for the object to be analyzed based on the node contribution degree.

### CROSS REFERENCE TO RELATED APPLICATION

This application claims priority from Chinese Patent Application No. 202211488180.3, filed on Nov. 25, 2022, the contents of which are hereby incorporated by reference in their entirety for all purposes.

### TECHNICAL FIELD

The present disclosure relates to a technical field of data processing, and in particular, to an attribution analysis method, an electronic device, and a storage medium.

### BACKGROUND

Attribution analysis is an analysis method for explaining components of a phenomenon or an effect. At present, the attribution analysis method is widely used in various types of applications such as e-commerce, advertising, and consulting. Business optimization can be achieved by correctly attributing business data.

### SUMMARY

Embodiments of the present disclosure at least provide an attribution analysis method, an attribution analysis apparatus, an electronic device, and a storage medium.

In a first aspect, an embodiment of the present disclosure provides an attribution analysis method, comprising: acquiring target business data of an object to be analyzed, and acquiring a plurality of levels of data dimensions of the target business data, wherein the data dimensions are associated with data types of the target business data; determining a target Trie tree based on the data dimensions and the target business data, wherein nodes at each level in the target Trie tree correspond to the data dimension at one level, and each node at individual levels is associated with the target business data belonging to the corresponding data dimension; determining a node contribution degree of each node in the target Trie tree based on the target business data, wherein the node contribution degree is used to indicate an impact of each node on a business indicator of the object to be analyzed; performing an anomaly attribution analysis for the object to be analyzed based on the node contribution degree.

In an optional implementation, the determining the target Trie tree based on the data dimensions and the target business data comprises: determining attribute data in the target business data matching each of the data dimensions according to a level relationship of the data dimensions, to obtain a target data sequence; associating the target business data with an initial Trie tree according to the target data sequence, to obtain the target Trie tree.

In an optional implementation, the associating the target business data with the initial Trie tree according to the target data sequence to obtain the target Trie tree comprises: determining, in the initial Trie tree, a target path matching the target data sequence, wherein the target path comprises a first node matching each piece of attribute data in the target data sequence; associating corresponding target business data with a corresponding first node of the target path based on individual attribute data, to obtain the target Trie tree.

In an optional implementation, the determining the node contribution degree of each node in the target Trie tree based on the target business data comprises: determining an indicator value of an indicator to be analyzed for the object to be analyzed based on the target business data, to obtain a first indicator value; determining an indicator value of the indicator to be analyzed for the object to be analyzed based on the target business data associated with each node, to obtain a second indicator value; determining the node contribution degree of the node based on the first indicator value and the second indicator value.

In an optional implementation, the performing the anomaly attribution analysis for the object to be analyzed based on the node contribution degree comprises: determining a first node path among a plurality of node paths of the target Trie tree based on the node contribution degree, wherein a plurality of consecutive nodes are included in the first node path, and the node contribution degree of each node of the consecutive nodes is greater than or equal to a contribution degree threshold; performing the anomaly attribution analysis for the object to be analyzed based on the first node path.

In an optional implementation, the determining the first node path among the plurality of node paths of the target Trie tree based on the node contribution degree comprises: starting from a root node of the target Trie tree, traversing the node contribution degree of each node in individual node paths of the target Trie tree, until a second node with the node contribution degree less than the contribution degree threshold is traversed; determining the first node path based on the nodes preceding the second node in the traversed node path.

In an optional implementation, the performing the anomaly attribution analysis for the object to be analyzed based on the node contribution degree comprises: in a case where there are a plurality of first node paths, performing the anomaly attribution analysis for the object to be analyzed based on the node contribution degrees of individual nodes in each of the first node paths, to obtain attribution analysis results corresponding to individual first node paths.

In a second aspect, an embodiment of the present disclosure further provides an attribution analysis apparatus, comprising: an acquisition unit for acquiring target business data of an object to be analyzed, and acquiring a plurality of levels of data dimensions of the target business data, wherein the data dimensions are associated with data types of the target business data; a first determination unit for determining a target Trie tree based on the data dimensions and the target business data, wherein nodes at each level in the target Trie tree correspond to the data dimension at one level, and each node at individual levels is associated with the target business data belonging to the corresponding data dimension; a second determination unit for determining a node contribution degree of each node in the target Trie tree based on the target business data, wherein the node contribution degree is used to indicate an impact of each node on a business indicator of the object to be analyzed; an analysis unit for performing an anomaly attribution analysis for the object to be analyzed based on the node contribution degree.

In a third aspect, an embodiment of the present disclosure further provides an electronic device comprising: a processor, a memory and a bus, the memory having machine-readable instructions executable by the processor stored thereon, the processor communicating with the memory via the bus when the electronic device is in operation, the above steps in the first aspect or in any possible implementation of the first aspect being performed when the machine-readable instructions are executed by the processor.

In a fourth aspect, an embodiment of the present disclosure further provides a computer-readable storage medium, the computer-readable storage medium having a computer program stored thereon, the above steps in the first aspect or in any possible implementation of the first aspect being performed when the computer program is executed by a processor.

In order to make the objects, features and advantages of the present disclosure more apparent and understandable, preferred embodiments are given and described below in detail in conjunction with the accompanying drawings.

### BRIEF DESCRIPTION OF THE DRAWINGS

In order to illustrate technical solutions of embodiments of the present disclosure more clearly, the drawings required to be used in the embodiments will be briefly introduced below. The drawings herein are incorporated into the description and constitute a part of the description. The drawings illustrate embodiments in conformity with the present disclosure and, together with the description, are used to illustrate the technical solutions of the present disclosure. It should be understood that the following drawings only illustrate some embodiments of the present disclosure, and therefore should not be regarded as limitations to the scope. Those of ordinary skill in the art can further obtain other relevant drawings according to these drawings, without exerting creative efforts.

FIG. 1 illustrates a flow chart of an attribution analysis method provided by an embodiment of the present disclosure;

FIG. 2 illustrates a structural schematic diagram of a target Trie tree provided by an embodiment of the present disclosure;

FIG. 3 illustrates a flow chart of a specific method for determining a target Trie tree based on data dimensions and target business data in the attribution analysis method provided by an embodiment of the present disclosure;

FIG. 4 illustrates a flow chart of a specific method for determining a node contribution degree of each node in the target Trie tree based on target business data in the attribution analysis method provided by an embodiment of the present disclosure;

FIG. 5 illustrates a flow chart of a specific method for performing an anomaly attribution analysis for an object to be analyzed based on the node contribution degree in the attribution analysis method provided by an embodiment of the present disclosure;

FIG. 6 illustrates a schematic diagram of an attribution analysis apparatus provided by an embodiment of the present disclosure; and

FIG. 7 illustrates a schematic diagram of an electronic device provided by an embodiment of the present disclosure.

### DETAILED DESCRIPTION

In order to make objects, technical solutions and advantages of the embodiments of the present disclosure clearer, the technical solutions in the embodiments of the present disclosure will be clearly and completely described below in conjunction with the accompanying drawings in the embodiments of the present disclosure. Obviously, the described embodiments are only a part of the embodiments of the present disclosure, not all of the embodiments. Components of the embodiments of the present disclosure described and illustrated in the accompanying drawings herein may generally be arranged and designed in a variety of different configurations. Therefore, the following detailed description of the embodiments of the present disclosure provided in the accompanying drawings is not intended to limit the claimed scope of the present disclosure, but rather to represent selected embodiments of the present disclosure. Based on the embodiments of the present disclosure, all other embodiments obtained by those skilled in the art without any creative efforts shall fall within the protection scope of the present disclosure.

It should be noted that, similar reference numerals and letters represent similar items in the following accompanying drawings. Therefore, once an item is defined in one figure, further definition and explanation of the item are not required in the subsequent figures.

The term “and/or” herein merely describes an associative relationship, indicating that there can be three relationships, for example, A and/or B can represent that A exists alone, both A and B exist simultaneously, and B exists alone. Moreover, the term “at least one” herein represents any combination of any one of a plurality or at least two of the plurality, for example, including at least one of A, B, or C may represent including any one or more elements selected from a collection consisting of A, B, and C.

It has been found by a research that in related attribution analysis techniques, it is usually necessary to determine drill-down dimensions of the business data. Then, a contribution degree of each link/node in the drill-down dimensions can be determined so as to continuously optimize recommendations and business paths. However, in the related art, usually relevant personnel specify drill-down dimensions of the data and calculate a contribution degree of each drill-down dimension. However, in the related technical solution of manually specifying the drill-down dimensions, it is necessary to manually set the drill-down dimensions, as well as depths of the drill-down dimensions. In addition, it is further necessary to manually record an intermediate result of the drill-down process. Therefore, the technical solution has a low degree of automation and requires a large investment of human and material resources. The related technical solution of manually specifying the drill-down dimensions requires an interaction between a staff and a machine. Therefore, for each selection of the drill-down dimensions, it is necessary to trigger a real-time calculation of the contribution degree. Therefore, calculating the contribution degree by manually specifying the drill-down dimensions has a relative low calculation efficiency, and the experience during the interaction is not friendly. Therefore, a real-time requirement for existing applications cannot be satisfied.

Based on the above research, the present disclosure provides an attribution analysis method, an attribution analysis apparatus, an electronic device, and a storage medium. In an embodiment of the present disclosure, firstly, the target business data of the object to be analyzed is acquired, and then the plurality of levels of the data dimensions of the target business data can be determined, and then the target Trie tree is determined based on the data dimensions and the target business data, wherein a plurality of levels of nodes are included in the target Trie tree, each level corresponds to the data dimension at one level, and each node at individual levels corresponds to target business data of the corresponding data dimension. After that, the node contribution degree of each node in the target Trie tree can be determined based on the target business data, thereby an anomaly attribution analysis can be performed for the object to be analyzed based on the node contribution degree. In the above implementation, by constructing the target Trie tree based on the data dimensions and the target business data, a plurality of drill-down paths under the data dimensions can be enumerated at one time, thereby the contribution degrees of the plurality of drill-down paths are calculated at one time. By this processing method, a manual and complex analysis process can be omitted, and a calculation efficiency is optimized with a higher flexibility, and an existing problem of incomplete drill-down paths in data dimensions is avoided.

In order to facilitate understanding of the present embodiment, firstly an attribution analysis method disclosed in an embodiment of the present disclosure is introduced in detail, and a subject performing the attribution analysis method provided in the embodiment of the present disclosure is generally an electronic device with a certain computational capability. The electronic device includes, for example, a terminal device, a server or another processing device. In some possible implementations, the attribution analysis method may be realized by a processor invokes computer-readable instructions stored in a memory.

Referring to FIG. 1, a flowchart of an attribution analysis method provided by an embodiment of the present disclosure is shown. The method comprises steps S101 to S107, wherein:

S101: acquiring target business data of an object to be analyzed, and acquiring a plurality of levels of data dimensions of the target business data; wherein the data dimensions are associated with data types of the target business data.

In an embodiment of the present disclosure, the object to be analyzed may be understood as various businesses that need to be subjected to attribution analysis, such as an advertising business, an insurance business, a XXX benefit issuance business to be analyzed.

Herein, the target business data can be understood as business observation data of the object to be analyzed, wherein the business data in the target business data belongs to a plurality of data types, and the data types are associated with the data dimensions, that is, the data types are the same as or corresponding to the data dimensions.

Herein, a level relationship of the data dimensions of the target business data may be used to indicate a level relationship of at least a part of the data dimensions in the target business data. For example, the data dimensions comprise A, B, and C. At this time, the level relationship of the data dimensions is A-B-C.

That is, the plurality of data dimensions may be understood as a plurality of drill-down dimensions, and the level relationship of the plurality of data dimensions may be understood as a drill-down sequence of the plurality of drill-down dimensions.

S103: determining a target Trie tree based on the data dimensions and the target business data; wherein nodes at each level in the target Trie tree correspond to the data dimension at one level, and each node at individual levels is associated with the target business data belonging to the corresponding data dimension.

In an embodiment of the present disclosure, the target Trie tree comprises a plurality of levels, and each level comprises at least one node, wherein the highest level of the target Trie tree is a root node, and the root node is a null node. Herein, each data dimension may include a plurality of types of target business data. For example, in the case where a data dimension is an operating system, the target business data may be an IOS system or an Android system. In the embodiment of the present disclosure, for each node at any level, the node may be set to correspond to a type of target business data under a data dimension corresponding to that level, and the nodes corresponding to different parent nodes at the same level may corresponds to the same target business data.

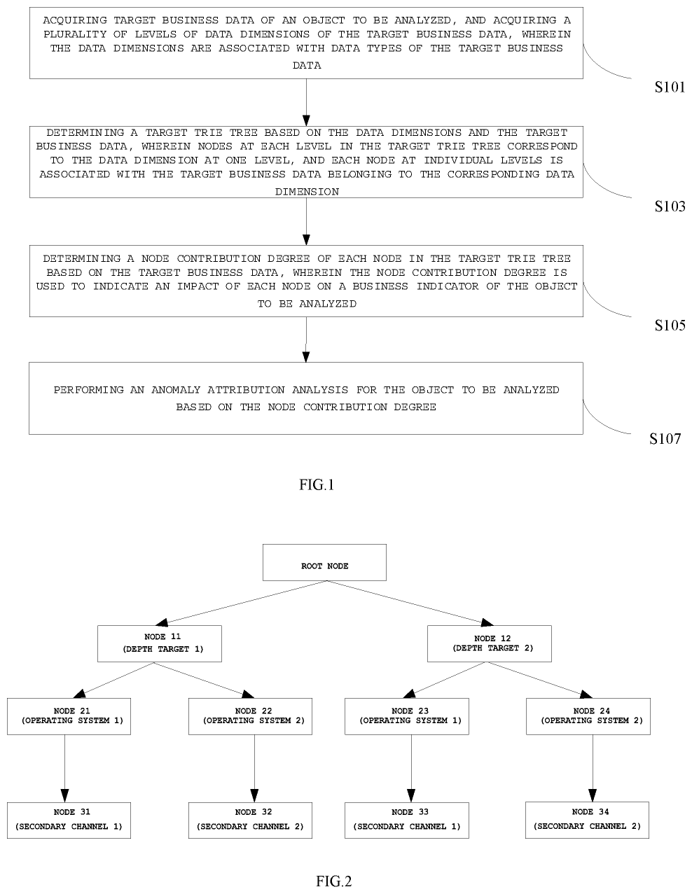

As shown in FIG. 2, it shows an optional target Trie tree. As shown in FIG. 2, this target Trie tree includes four levels, wherein the highest level is the level where the root node is located. Node 11 and node 12 of the target Trie tree are located at the second level, nodes 21 to 24 of the target Trie tree are located at the third level, and nodes 31 to 34 of the target Trie tree are located at the fourth level.

Assuming that the plurality of levels of the data dimensions are: Depth Target-Operating System-Secondary Channel. At this time, the depth target corresponds to a node at the first level, the operating system corresponds to a node at the second level, and the secondary channel corresponds to a node at the third level. If the depth target includes a depth target 1 and a depth target 2, the operating system includes an operating system 1 and an operating system 2, and the secondary channel includes a secondary channel 1 and a secondary channel 2, then the node 11 may be the depth target 1 and the node 12 may be the depth target 2; the node 21 and the node 23 may be the operating system 1, and the node 22 and the node 24 may be the operating system 4; and the node 31 and the node 33 may be the secondary channel 1, and the node 32 and the node 34 may be the secondary channel 2.

Since the acquired target business data has a plurality of data dimensions, the plurality of data dimensions can be recorded as a data dimension sequence.

In an embodiment of the present disclosure, different data dimensions may be selected to be sorted according to different level relationships, thereby obtaining different data dimension sequences. At this time, one target Trie tree may be determined based on each data dimension sequence, and the above process described in steps S105 and S107 may be performed for the target Trie tree, thereby determining the analysis result of the anomaly attribution analysis for the object to be analyzed based on each target Trie tree.

Herein, including a plurality of different data dimension sequences can be understood as the data dimensions in each data dimension sequence being different, and/or the level relationships of the data dimensions being different.

S105: determining a node contribution degree of each node in the target Trie tree based on the target business data; wherein the node contribution degree is used to indicate an impact of each node on a business indicator of the object to be analyzed.

In an embodiment of the present disclosure, corresponding indicators to be analyzed are set for each target Trie tree, wherein the indicators to be analyzed for different target Trie trees may be same or different, and the present disclosure does not make a specific limitation therefor.

For different indicators to be analyzed, different indicator values can be determined based on target business data. At this time, a node contribution degree of each node can be determined based on the indicator value corresponding to the each node, thereby obtaining the node contribution degree of the each node in the target Trie tree.

S107: performing an anomaly attribution analysis for the object to be analyzed based on the node contribution degree.

In a specific implementation, a contribution degree requirement may be set in advance, wherein the contribution degree requirement is determined based on a contribution degree threshold. Then, the node contribution degree is compared with the contribution degree threshold, so as to screen nodes that are greater than or equal to the contribution degree threshold according to the comparison result. After that, an anomaly attribution analysis is performed for the object to be analyzed, according to a node path of nodes in the target Trie tree with node contribution degrees consecutively greater than or equal to the contribution degree threshold.

In an embodiment of the present disclosure, firstly, the target business data of the object to be analyzed is acquired, and then the plurality of levels of the data dimensions of the target business data can be determined, and then the target Trie tree is determined based on the data dimensions and the target business data, wherein a plurality of levels of nodes are included in the target Trie tree, each level corresponds to the data dimension at one level, and each node at individual levels corresponds to target business data of the corresponding data dimension. After that, the node contribution degree of each node in the target Trie tree can be determined based on the target business data, thereby an anomaly attribution analysis can be performed for the object to be analyzed based on the node contribution degree. In the above implementation, by constructing the target Trie tree based on the data dimensions and the target business data, a plurality of drill-down paths under the data dimensions can be enumerated at one time, thereby the contribution degrees of the plurality of drill-down paths are calculated at one time. By this processing method, a manual and complex analysis process can be omitted, and a calculation efficiency is optimized with a higher flexibility, and an existing problem of incomplete drill-down paths in data dimensions is avoided.

The above steps will be described in detail below in connection with specific implementations.

As can be seen from the above description, in an embodiment of the present disclosure, firstly the target business data of the object to be analyzed is acquired, and the data dimensions of the target business data are acquired.

In a specific implementation, a business party may in advance set at least one data dimension sequence of the object to be analyzed. Upon performing an anomaly attribution analysis for the object to be analyzed, the at least one data dimension sequence in advance set by the business party may be acquired. In addition, the attribution analysis system may also in advance set the at least one data dimension sequence for the object to be analyzed, based on the indicators to be analyzed for the object to be analyzed.

In an embodiment of the present disclosure, a level relationship of individual data dimensions in each data dimension sequence may be determined based on weights of the data dimensions, wherein the weights are used to indicate importance degrees or impact degrees of the data dimensions on the indicators to be analyzed (or the object to be analyzed).

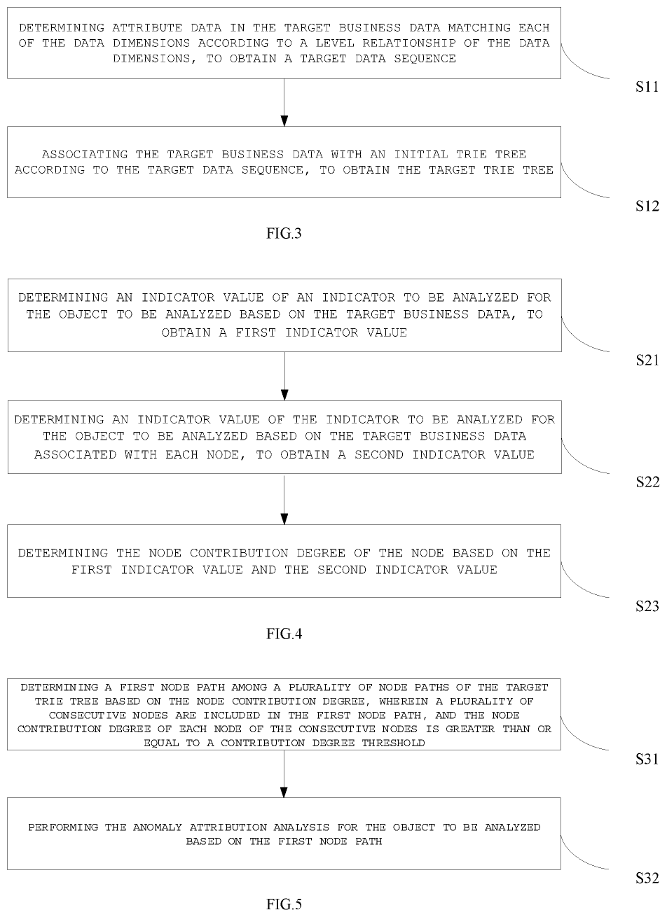

After obtaining the target business data and the data dimension sequence (or, the plurality of data dimensions), step S103 can be performed: determining a target Trie tree based on the data dimensions and the target business data, wherein as shown in FIG. 3, the step S103 specifically comprises the following steps:
Step S11: determining attribute data in the target business data matching each of the data dimensions, according to a level relationship of the data dimensions, to obtain a target data sequence;
Step S12: associating the target business data with an initial Trie tree according to the target data sequence, to obtain the target Trie tree.

In an embodiment of the present disclosure, firstly a null tree and a root node are established, wherein the root node is used to indicate the object to be analyzed. As can be seen from the above description, each data dimension sequence may include a plurality of data dimensions and a level relationship of the data dimensions. On the basis of this, after acquiring the data dimensions, attribute data matching individual data dimensions in each target business data may be determined based on the level relationship of the data dimensions, thereby obtaining the target data sequence.

In a specific implementation, firstly a dataset including a plurality of rows of target business data is acquired, and then, each row of the target business data in the dataset is traversed. For each row of the target business data, index data of the row of the target business data is generated, according to the set level relationship (that is, the drill-down sequence). For example, the level relationship set above is: “Depth target-Operating platform-Secondary channel”, and then the index data generated for the row of the target business data may be: “Depth Retention-IOS-Internal Mutual Push”. Wherein this index data is the target data sequence described above.

For each data dimension, an attribute field matching the data dimension can be determined in the target business data, and a field content of the attribute field can be extracted. For example, the attribute field is “depth target” and the field content is “depth retention”. At this time, the field content can be used as attribute data in the target business data matching the data dimension “depth target”. After sequentially obtaining the attribute data matching each data dimension, a plurality of attribute sequences can be combined according to a level relationship, so as to obtain a target data sequence.

After the target data sequence is determined, the target business data can be associated with the initial Trie tree according to the target data sequence, so as to obtain the target Trie tree.

Herein, the initial Trie tree can be traversed according to the index data (i.e., the target data sequence) and each row of the target business data. After the traversal, if it is determined that a node corresponding to the index data exists, the row of target business data is accumulated at the node, and if it is determined that a node corresponding to the index data does not exist, a new node is created according to the index data, and then the row of the target business data is accumulated. Then, the index data at the next level continues to be processed, and the child nodes of the nodes at current level are traversed in the initial Trie tree, until a corresponding node has been determined for each piece of index data in the initial Trie tree, then the process ends and the target Trie tree is obtained.

In an optional implementation, the above step S12 of associating the target business data with the initial Trie tree according to the target data sequence to obtain the target Trie tree specifically comprises the following steps:
Step S121: determining, in the initial Trie tree, a target path matching the target data sequence; wherein the target path comprises a first node matching each piece of attribute data in the target data sequence;
Step S122: associating corresponding target business data with a corresponding first node of the target path based on individual attribute data, to obtain the target Trie tree.

In the embodiment of the present disclosure, firstly, the attribute data to be indexed is determined in the target data sequence, which is marked as attribute data A; and then, a level (marked as level B) corresponding to the attribute data A is determined in the initial Trie tree, and nodes (marked as nodes C) included in the level B are determined. Next, a node matching the attribute data A is searched in the nodes C. Wherein if the matching node is found, the target business data corresponding to the attribute data A is accumulated to the node; and if the matching node is not found, a node matching the attribute data A is created in the level B of the initial Trie tree, and the target business data corresponding to the attribute data A is accumulated to the created node.

Herein, for each target data sequence, a path formed by nodes in each level of the initial Trie tree matching the individual attribute data of the target data sequence is a target path of the target data sequence. By accumulating the target business data to the first node corresponding to the target path, individual target business data can be associated with the initial Trie tree, thereby obtaining the target Trie tree.

As can be seen from the above description, in an embodiment of the present disclosure, with the above traversal process, all effective drill-down paths for each piece of target business data, as well as intermediate business data of individual paths, can be completely built. Therefore, the manual and complex analysis process can be omitted, and the calculation efficiency is optimized.

In an optional implementation, as shown in FIG. 4, the above step S105 of determining the node contribution degree of each node in the target Trie tree based on the target business data specifically comprises the following steps:
Step S21: determining an indicator value of an indicator to be analyzed for the object to be analyzed based on the target business data, to obtain a first indicator value;
Step S22: determining an indicator value of the indicator to be analyzed for the object to be analyzed based on the target business data associated with each node, to obtain a second indicator value;
Step S23: determining the node contribution degree of the node based on the first indicator value and the second indicator value.

After the attribution drill-down Trie tree (i.e., the target Trie tree) is successfully built, it is necessary to analyze a node in the target Trie tree that has the greatest impact on the object to be analyzed or on nodes at an upper level. At this time, a node contribution degree can be calculated for a node. For example, the contribution degree of a node can be calculated by using a method such as an elimination process and a weighted percentage method. Hereinafter, the elimination process is illustrated as an example.

In a specific implementation, the target business data can be used to determine the indicator value of the indicator to be analyzed for the object to be analyzed, thereby obtaining the first indicator value M. After that, for a current node currently to be calculated, target business data corresponding to the node can be removed, and remaining target business data can be obtained, and based on the remaining target business data, the indicator value of the indicator to be analyzed for the object to be analyzed after the target business data corresponding to the node being removed is determined, so as to obtain the second indicator value Pᵢ.

Next, the node contribution degree of the node can be determined based on the first indicator value and the second indicator value. For example, the node contribution degree of the node can be calculated in the following way:

$${C}_{i} = \frac{M - {P}_{i}}{M} ;$$

wherein Cᵢ represents the node contribution degree of the node, Cᵢ is a signed number, the absolute value of Cᵢ indicates an amplitude of the impact, and the sign of Cᵢ represents whether the impact is a positive impact or a negative impact.

In an embodiment of the present disclosure, after the node contribution degree of each node is determined, an anomaly attribution analysis can be performed for the object to be analyzed based on the node contribution degree, as shown in FIG. 5, which specifically comprises the following steps:
Step S31: determining a first node path among a plurality of node paths of the target Trie tree, based on the node contribution degree; wherein a plurality of consecutive nodes are included in the first node path, and the node contribution degree of each node of the consecutive nodes is greater than or equal to a contribution degree threshold;
Step S32: performing the anomaly attribution analysis for the object to be analyzed based on the first node path.

In an embodiment of the present disclosure, after the node contribution degree is determined, the nodes in the target Trie tree can be traversed according to the node contribution degree, thereby traversing a plurality of node paths (also called expansion paths) of the target Trie tree, to obtain the first node path.

Herein, there may be a plurality of first node paths, and the number of nodes included in a first node path is less than or equal to the depth (or the number of levels) of the target Trie tree, that is, a first node path may be a partial node path in a complete node path. Further, each node in the above first node path is a node at a consecutive level.

For example, as shown in FIG. 2, it includes 4 node paths: node path 1 (root node-node 11-node 21-node 31), node path 2 (root node-node 11-node 22-node 32), node path 3 (root node-node 12-node 23-node 33), and node path 4 (root node-node 12-node 24-node 34). At this time, the first node path can be determined among the four node paths. If the node contribution degree of each node in the node path 1 satisfies the contribution degree requirement (that is, the node contribution degree is greater than or equal to the contribution degree threshold), the node path 1 is the first node path. For another example, if the node contribution degrees of node 11 and node 21 in the node path 1 satisfy the contribution degree requirement, the first node path is: root node-node 11-node 21.

After the first node path is obtained in the manner described above, an anomaly attribution analysis can be performed for the object to be analyzed based on the first node path.

In a case where there are a plurality of first node paths, the anomaly attribution analysis is performed for the object to be analyzed based on the node contribution degrees of individual nodes in each of the first node paths, to obtain attribution analysis results corresponding to individual first node paths.

In an optional implementation, the above step S31 of determining the first node path among the plurality of node paths in the target Trie tree based on the node contribution degree specifically comprises the following steps:
Step S311: Starting from a root node of the target Trie tree, traversing the node contribution degree of each node in individual node paths of the target Trie tree, until a second node with the node contribution degree less than the contribution degree threshold is traversed;
Step S312: determining the first node path based on the nodes preceding the second node in the traversed node path.

In an embodiment of the present disclosure, firstly, starting from the root node of the target Trie tree, a child node (i.e., child node 1) of the root node is determined, and the node contribution degree (i.e., node contribution degree 1) of the child node 1 is determined. Then, the node contribution degree 1 is compared with the contribution degree threshold 1, wherein if the comparison shows that the node contribution degree 1 is greater than or equal to the contribution degree threshold 1, it is determined that the child node 1 satisfies the contribution degree requirement, and then a child node (i.e., child node 2) of the child node 1 is continued to be traversed. If the comparison shows that the node contribution degree 1 is less than the contribution degree threshold 1, it is determined that the child node 1 does not satisfy the contribution requirement. At this time, the child node 1 is discarded and the nodes after the child node 1 are pruned from the target Trie tree.

For the child node 2, the node contribution degree (i.e., node contribution degree 2) of the child node 2 can be determined. Then, the node contribution degree 2 is compared with the contribution degree threshold 2, wherein if the comparison shows that the node contribution degree 2 is greater than or equal to the contribution degree threshold 2, it is determined that the child node 2 satisfies the contribution degree requirement, and then a child node of the child node 2 is continued to be traversed.

In an embodiment of the present disclosure, the node contribution degree of each node in each node path can be traversed in the manner described above, until a node not satisfying the contribution degree requirement (i.e., a node with the node contribution degree smaller than the corresponding contribution degree threshold) is traversed. Finally, the nodes preceding the node not satisfying the contribution degree requirement in the traversed node path are determined as the first node path.

Herein, for nodes at each level, the same or different contribution degree thresholds can be set. That is, the contribution degree threshold 1 corresponding to child node 1 can be the same as or different from the contribution degree threshold 2 corresponding to child node 2. The present disclosure does not make a specific limitation therefor, as long as it can be implemented.

In the above embodiment, by the above processing manner, a plurality of drill-down paths under the data dimensions can be enumerated at one time, thereby the first node path satisfying the contribution degree requirement is calculated among a plurality of expansion paths at one time. By this processing method, a manual and complex analysis process can be omitted, and a calculation efficiency is optimized with a higher flexibility, and an existing problem of incomplete drill-down paths in data dimensions is avoided.

It can be understood by those skilled in the art that in the above method of the detailed description, the written sequence of each step does not mean a strict execution sequence and does not constitute any limitation to the implementation process, and the specific execution sequence of each step should be determined based on its function and possible internal logic.

Based on the same inventive concept, an embodiment of the present disclosure also provides an attribution analysis apparatus corresponding to the attribution analysis method. Since the principle in solving the problem of the apparatus in the embodiment of the present disclosure is similar to the above attribution analysis method in the embodiment of the present disclosure, the implementation of the apparatus can be referred to the implementation of the method, and redundant description thereof will be omitted.

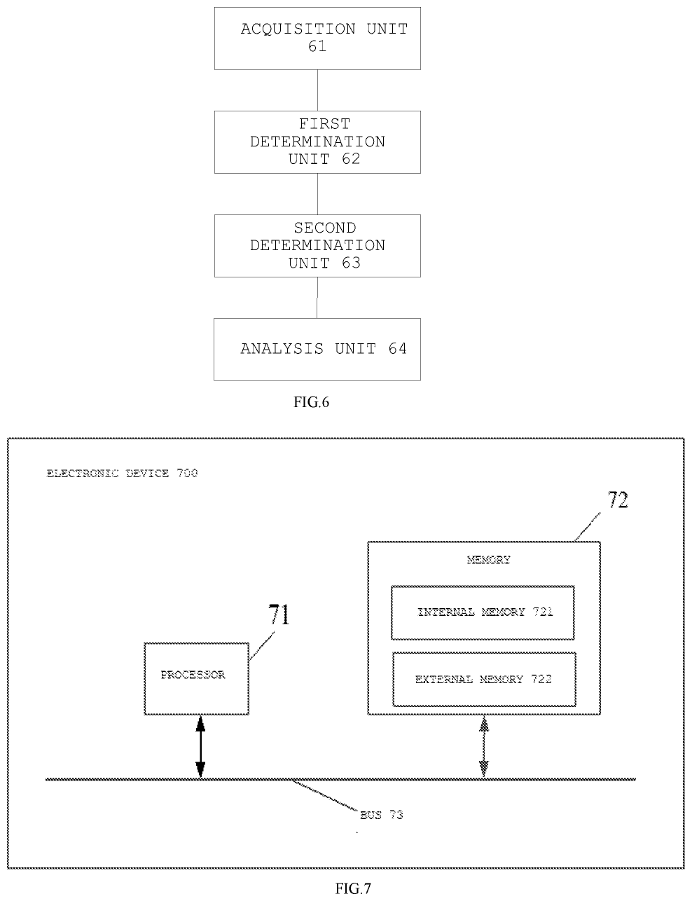

Referring to FIG. 6, a schematic diagram of an attribution analysis apparatus provided by an embodiment of the present disclosure is shown, the apparatus comprises an acquisition unit 61, a first determination unit 62, a second determination unit 63, and an analysis unit 64.

The acquisition unit 61 is used to acquire target business data of an object to be analyzed, and acquire a plurality of levels of data dimensions of the target business data, wherein the data dimensions are associated with data types of the target business data.

The first determination unit 62 is used to determine a target Trie tree based on the data dimensions and the target business data, wherein nodes at each level in the target Trie tree correspond to the data dimension at one level, and each node at individual levels is associated with the target business data belonging to the corresponding data dimension.

The second determination unit 63 is used to determine a node contribution degree of each node in the target Trie tree based on the target business data, wherein the node contribution degree is used to indicate an impact of each node on a business indicator of the object to be analyzed.

The analysis unit 64 is used to perform an anomaly attribution analysis for the object to be analyzed based on the node contribution degree.

In an embodiment of the present disclosure, firstly, the target business data of the object to be analyzed is acquired, and then the plurality of levels of the data dimensions of the target business data can be determined, and then the target Trie tree is determined based on the data dimensions and the target business data, wherein a plurality of levels of nodes are included in the target Trie tree, each level corresponds to the data dimension at one level, and each node at individual levels corresponds to target business data of the corresponding data dimension. After that, the node contribution degree of each node in the target Trie tree can be determined based on the target business data, thereby an anomaly attribution analysis can be performed for the object to be analyzed based on the node contribution degree. In the above implementation, by constructing the target Trie tree based on the data dimensions and the target business data, a plurality of drill-down paths under the data dimensions can be enumerated at one time, thereby the contribution degrees of the plurality of drill-down paths are calculated at one time. By this processing method, a manual and complex analysis process can be omitted, and a calculation efficiency is optimized with a higher flexibility, and an existing problem of incomplete drill-down paths in data dimensions is avoided.

In a possible implementation, the first determining unit is further used to determine attribute data in the target business data matching each of the data dimensions according to a level relationship of the data dimensions, to obtain a target data sequence; associate the target business data with an initial Trie tree according to the target data sequence, to obtain the target Trie tree.

In a possible implementation, the first determining unit is further used to determine, in the initial Trie tree, a target path matching the target data sequence, wherein the target path comprises a first node matching each piece of attribute data in the target data sequence; associate corresponding target business data with a corresponding first node of the target path based on individual attribute data, to obtain the target Trie tree.

In a possible implementation, the second determination unit is further used to determine an indicator value of an indicator to be analyzed for the object to be analyzed based on the target business data, to obtain a first indicator value; determine an indicator value of the indicator to be analyzed for the object to be analyzed based on the target business data associated with each node, to obtain a second indicator value; determine the node contribution degree of the node based on the first indicator value and the second indicator value.

In a possible implementation, the analysis unit is further used to determine a first node path among a plurality of node paths of the target Trie tree based on the node contribution degree, wherein a plurality of consecutive nodes are included in the first node path, and the node contribution degree of each node of the consecutive nodes is greater than or equal to a contribution degree threshold; perform the anomaly attribution analysis for the object to be analyzed based on the first node path.

In a possible implementation, the analysis unit is further used to, starting from a root node of the target Trie tree, traverse the node contribution degree of each node in individual node paths of the target Trie tree, until a second node with the node contribution degree less than the contribution degree threshold is traversed; determine the first node path based on the nodes preceding the second node in the traversed node path.

In a possible implementation, the analysis unit is further used to, in a case where there are a plurality of first node paths, perform the anomaly attribution analysis for the object to be analyzed based on the node contribution degrees of individual nodes in each of the first node paths, to obtain attribution analysis results corresponding to individual first node paths.

The description of the processing flow of individual modules in the apparatus and the interaction flow between individual modules may be referred to the relevant description in the above method embodiment, and will not be described in detail herein.

An embodiment of the present disclosure further provides an electronic device 700 corresponding to the attribution analysis method in FIG. 1. As shown in FIG. 7, a structural schematic diagram of the electronic device 700 provided by the embodiment of the present disclosure is shown, and the electronic device 700 comprises:
a processor 71, a memory 72, and a bus 73, the memory 72 is used to store execution instructions, and includes an internal memory 721 and an external memory 722, and the internal memory 721 herein is also called internal storage and is used to temporarily store the operation data in the processor 71 and the data exchanged with the external memory 722 such as a hard disk. The processor 71 exchanges data with the external memory 722 via the internal memory 721. When the electronic device 700 is in operation, the processor 71 communicates with the memory 72 via the bus 73, so that the processor 71 executes the following instructions of:
acquiring target business data of an object to be analyzed, and acquiring a plurality of levels of data dimensions of the target business data, wherein the data dimensions are associated with data types of the target business data;
determining a target Trie tree based on the data dimensions and the target business data, wherein nodes at each level in the target Trie tree correspond to the data dimension at one level, and each node at individual levels is associated with the target business data belonging to the corresponding data dimension;
determining a node contribution degree of each node in the target Trie tree based on the target business data, wherein the node contribution degree is used to indicate an impact of each node on a business indicator of the object to be analyzed;
performing an anomaly attribution analysis for the object to be analyzed based on the node contribution degree.

An embodiment of the present disclosure further provides a computer-readable storage medium, the computer-readable storage medium has stored a computer program thereon, and when the computer program is executed by a processor, the steps of the attribution analysis method described in the above method embodiment are executed. The storage medium may be a volatile or non-volatile computer-readable storage medium.

An embodiment of the present disclosure further provides a computer program product, the computer program product carries program codes, and the instructions included in the program codes can be used to perform the steps of the attribution analysis method described in the above method embodiment. Details can be referred to the above method embodiment, and will not be described in further detail herein.

The above computer program product can be specifically implemented by hardware, software or a combination thereof. In an optional implementation, the computer program product is specifically embodied as a computer storage medium, and in another optional implementation, the computer program product is specifically embodied as a software product, such as a Software Development Kit (SDK) and the like.

It could be clearly understood by those skilled in the art that, for convenience and brevity of description, the specific working process of the system and the apparatus described above can be referred to corresponding process in the foregoing method embodiment, and will not be described in further detail herein. In the several embodiments provided in the present disclosure, it should be understood that the disclosed system, apparatus and method can be implemented in other ways. The apparatus embodiment described above are only illustrative. For example, the division of the units is only a logical function division. In actual implementation, there may be other divisions. For example, a plurality of units or components may be combined or may be integrated into another system, or some features can be ignored, or not implemented. In addition, the coupling or direct coupling or communication connection between each other shown or discussed components may be via some communication interfaces, and the indirect coupling or communication connection of the apparatuses or units may be in electrical, mechanical or other forms.

The units described as separate components may or may not be physically separated, and the components shown as units may or may not be physical units, that is, they may be located in one place, or they may be distributed over a plurality of network units. Some or all of the units may be selected to achieve the objects of the solution in the present embodiment according to actual needs.

Furthermore, individual functional units in various embodiments of the present disclosure may be integrated into one processing unit, or each unit may exist physically alone, or two or more units may be integrated into one unit.

If the functions are implemented in a form of software functional units and sold or used as independent products, they can be stored in a non-volatile computer-readable storage medium that is executable by a processor. On the basis of such understanding, the technical solution of the present disclosure is essentially embodied in the form of a software product, or the part that contributes to the related art or a part of the technical solution can be embodied in the form of a software product. The computer software product is stored in a storage medium, including several instructions for causing an electronic device (which may be a personal computer, a server, or a network device, etc.) to perform all or a part of steps of methods described in various embodiments of the present disclosure. The foregoing storage medium comprises various media that can store program codes, such as USB disk, mobile hard disk, Read-Only Memory (ROM), Random Access Memory (RAM), magnetic disk or optical disk.

Finally, it should be noted that, the above embodiments are only specific embodiments of the present disclosure used to illustrate the technical solutions of the present disclosure and not to limit thereto, and the protection scope of the present disclosure is not limited thereto. Although the present disclosure has been described in detail with reference to the foregoing embodiments, it should be understood by those of ordinary skill in the art that, any technician familiar with the present technical field, within the technical scope disclosed in the present disclosure, can still modify the technical solutions recited in the foregoing embodiments or easily conceive changes thereof, or make equivalent substitutions for some of the technical features, and these modifications, changes or substitutions do not cause the essence of the corresponding technical solutions to deviate from the spirit and scope of the technical solutions of the embodiments of the present disclosure, and they should all be covered in the protection scope of the present disclosure. Therefore, the protection scope of the present disclosure should be subject to the protection scope of the claims.

What is claimed is:

1. An attribution analysis method, comprising:
acquiring target business data of an object to be analyzed, and acquiring a plurality of levels of data dimensions of the target business data, wherein the data dimensions are associated with data types of the target business data;
determining a target Trie tree based on the data dimensions and the target business data, wherein nodes at each level in the target Trie tree correspond to the data dimension at one level, and each node at individual levels is associated with the target business data belonging to the corresponding data dimension;
determining a node contribution degree of each node in the target Trie tree based on the target business data, wherein the node contribution degree is used to indicate an impact of each node on a business indicator of the object to be analyzed;
performing an anomaly attribution analysis for the object to be analyzed based on the node contribution degree.

2. The method according to claim 1, wherein the determining the target Trie tree based on the data dimensions and the target business data comprises:
determining attribute data in the target business data matching each of the data dimensions according to a level relationship of the data dimensions, to obtain a target data sequence;
associating the target business data with an initial Trie tree according to the target data sequence, to obtain the target Trie tree.

3. The method according to claim 2, wherein the associating the target business data with the initial Trie tree according to the target data sequence to obtain the target Trie tree comprises:
determining, in the initial Trie tree, a target path matching the target data sequence, wherein the target path comprises a first node matching each piece of attribute data in the target data sequence;
associating corresponding target business data with a corresponding first node of the target path based on individual attribute data, to obtain the target Trie tree.

4. The method according to claim 1, wherein the determining the node contribution degree of each node in the target Trie tree based on the target business data comprises:
determining an indicator value of an indicator to be analyzed for the object to be analyzed based on the target business data, to obtain a first indicator value;
determining an indicator value of the indicator to be analyzed for the object to be analyzed based on the target business data associated with each node, to obtain a second indicator value;
determining the node contribution degree of the node based on the first indicator value and the second indicator value.

5. The method according to claim 1, wherein the performing the anomaly attribution analysis for the object to be analyzed based on the node contribution degree comprises:
determining a first node path among a plurality of node paths of the target Trie tree based on the node contribution degree, wherein a plurality of consecutive nodes are included in the first node path, and the node contribution degree of each node of the consecutive nodes is greater than or equal to a contribution degree threshold;
performing the anomaly attribution analysis for the object to be analyzed based on the first node path.

6. The method according to claim 5, wherein the determining the first node path among the plurality of node paths of the target Trie tree based on the node contribution degree comprises:
starting from a root node of the target Trie tree, traversing the node contribution degree of each node in individual node paths of the target Trie tree, until a second node with the node contribution degree less than the contribution degree threshold is traversed;
determining the first node path based on the nodes preceding the second node in the traversed node path.

7. The method according to claim 6, wherein the performing the anomaly attribution analysis for the object to be analyzed based on the node contribution degree comprises:
in a case where there are a plurality of first node paths, performing the anomaly attribution analysis for the object to be analyzed based on the node contribution degrees of individual nodes in each of the first node paths, to obtain attribution analysis results corresponding to individual first node paths.

8. An electronic device, comprising a processor, and a memory, the memory having machine-readable instructions executable by the processor stored thereon, wherein the machine-readable instructions, when executed by the processor, cause the electronic device to perform a method comprising:
acquiring target business data of an object to be analyzed, and acquiring a plurality of levels of data dimensions of the target business data, wherein the data dimensions are associated with data types of the target business data;
determining a target Trie tree based on the data dimensions and the target business data, wherein nodes at each level in the target Trie tree correspond to the data dimension at one level, and each node at individual levels is associated with the target business data belonging to the corresponding data dimension;
determining a node contribution degree of each node in the target Trie tree based on the target business data, wherein the node contribution degree is used to indicate an impact of each node on a business indicator of the object to be analyzed;
performing an anomaly attribution analysis for the object to be analyzed based on the node contribution degree.

9. The electronic device according to claim 8, wherein the determining the target Trie tree based on the data dimensions and the target business data comprises:
determining attribute data in the target business data matching each of the data dimensions according to a level relationship of the data dimensions, to obtain a target data sequence;
associating the target business data with an initial Trie tree according to the target data sequence, to obtain the target Trie tree.

10. The electronic device according to claim 9, wherein the associating the target business data with the initial Trie tree according to the target data sequence to obtain the target Trie tree comprises:
determining, in the initial Trie tree, a target path matching the target data sequence, wherein the target path comprises a first node matching each piece of attribute data in the target data sequence;
associating corresponding target business data with a corresponding first node of the target path based on individual attribute data, to obtain the target Trie tree.

11. The electronic device according to claim 8, wherein the determining the node contribution degree of each node in the target Trie tree based on the target business data comprises:
determining an indicator value of an indicator to be analyzed for the object to be analyzed based on the target business data, to obtain a first indicator value;
determining an indicator value of the indicator to be analyzed for the object to be analyzed based on the target business data associated with each node, to obtain a second indicator value;
determining the node contribution degree of the node based on the first indicator value and the second indicator value.

12. The electronic device according to claim 8, wherein the performing the anomaly attribution analysis for the object to be analyzed based on the node contribution degree comprises:
determining a first node path among a plurality of node paths of the target Trie tree based on the node contribution degree, wherein a plurality of consecutive nodes are included in the first node path, and the node contribution degree of each node of the consecutive nodes is greater than or equal to a contribution degree threshold;
performing the anomaly attribution analysis for the object to be analyzed based on the first node path.

13. The electronic device according to claim 12, wherein the determining the first node path among the plurality of node paths of the target Trie tree based on the node contribution degree comprises:
starting from a root node of the target Trie tree, traversing the node contribution degree of each node in individual node paths of the target Trie tree, until a second node with the node contribution degree less than the contribution degree threshold is traversed;
determining the first node path based on the nodes preceding the second node in the traversed node path.

14. The electronic device according to claim 13, wherein the performing the anomaly attribution analysis for the object to be analyzed based on the node contribution degree comprises:
in a case where there are a plurality of first node paths, performing the anomaly attribution analysis for the object to be analyzed based on the node contribution degrees of individual nodes in each of the first node paths, to obtain attribution analysis results corresponding to individual first node paths.

15. A non-transitory computer-readable storage medium, the computer-readable storage medium having a computer program stored thereon, wherein the computer program is executed by a processor to implement a method comprising:
acquiring target business data of an object to be analyzed, and acquiring a plurality of levels of data dimensions of the target business data, wherein the data dimensions are associated with data types of the target business data;
determining a target Trie tree based on the data dimensions and the target business data, wherein nodes at each level in the target Trie tree correspond to the data dimension at one level, and each node at individual levels is associated with the target business data belonging to the corresponding data dimension;
determining a node contribution degree of each node in the target Trie tree based on the target business data, wherein the node contribution degree is used to indicate an impact of each node on a business indicator of the object to be analyzed;
performing an anomaly attribution analysis for the object to be analyzed based on the node contribution degree.

16. The non-transitory computer-readable storage medium according to claim 15, wherein the determining the target Trie tree based on the data dimensions and the target business data comprises:
determining attribute data in the target business data matching each of the data dimensions according to a level relationship of the data dimensions, to obtain a target data sequence;
associating the target business data with an initial Trie tree according to the target data sequence, to obtain the target Trie tree.

17. The non-transitory computer-readable storage medium according to claim 16, wherein the associating the target business data with the initial Trie tree according to the target data sequence to obtain the target Trie tree comprises:
determining, in the initial Trie tree, a target path matching the target data sequence, wherein the target path comprises a first node matching each piece of attribute data in the target data sequence;
associating corresponding target business data with a corresponding first node of the target path based on individual attribute data, to obtain the target Trie tree.

18. The non-transitory computer-readable storage medium according to claim 15, wherein the determining the node contribution degree of each node in the target Trie tree based on the target business data comprises:
determining an indicator value of an indicator to be analyzed for the object to be analyzed based on the target business data, to obtain a first indicator value;
determining an indicator value of the indicator to be analyzed for the object to be analyzed based on the target business data associated with each node, to obtain a second indicator value;
determining the node contribution degree of the node based on the first indicator value and the second indicator value.

19. The non-transitory computer-readable storage medium according to claim 15, wherein the performing the anomaly attribution analysis for the object to be analyzed based on the node contribution degree comprises:
determining a first node path among a plurality of node paths of the target Trie tree based on the node contribution degree, wherein a plurality of consecutive nodes are included in the first node path, and the node contribution degree of each node of the consecutive nodes is greater than or equal to a contribution degree threshold;
performing the anomaly attribution analysis for the object to be analyzed based on the first node path.

20. The non-transitory computer-readable storage medium according to claim 19, wherein the determining the first node path among the plurality of node paths of the target Trie tree based on the node contribution degree comprises:
starting from a root node of the target Trie tree, traversing the node contribution degree of each node in individual node paths of the target Trie tree, until a second node with the node contribution degree less than the contribution degree threshold is traversed;
determining the first node path based on the nodes preceding the second node in the traversed node path.
